(19) United States
(12) Patent Application Publication
(10) Pub. No.: US 2016/0356081 A1
(43) Pub. Date: Dec. 8, 2016

(54) CORDLESS WINDOW COVERING

(71) Applicant: GUANGZHOU GARDEN RUBBER & PLASTIC CO., LTD., Guangzhou (CN)

(72) Inventors: Chou Ho SUNG, Guangzhou (CN); Dick CHEN, Guangzhou (CN); Bensheng LIU, Guangzhou (CN)

(73) Assignee: GUANGZHOU GARDEN RUBBER & PLASTIC CO., LTD., Guangzhou (CN)

(21) Appl. No.: 14/929,900

(22) Filed: Nov. 2, 2015

(30) Foreign Application Priority Data
Jun. 5, 2015 (CN) 201510307104.1
Jun. 5, 2015 (CN) 201520383794.4

(51) Int. Cl. E06B 9/32; E06B 9/327; E06B 9/303

(52) U.S. Cl. CPC E06B 9/32; E06B 9/303; E06B 9/327; E06B 2009/2625

(57) ABSTRACT

A cordless window covering for simplifying the winding manner of a pull cord includes a movable part, a telescopic part, a pull cord fixing seat and a pull cord. The telescopic part has one end fixedly connected to the external environment, and another end connected to the movable part, and the movable part is movable leftward and rightward along with the telescopic part. The pull cord fixing seat is configured to be fixedly connected to the external environment. The movable part is provided with at least one first transverse column arranged transversely, the pull cord fixing seat is provided with at least one second transverse column arranged transversely, and the pull cord passing through a window covering body is fixed to the movable part or the pull cord fixing seat after winding around the first transverse column and the second transverse column.

### CROSS-REFERENCE TO RELATED APPLICATIONS

This application claims the benefit of priorities to Chinese Patent Application No. 201510307104.1 and No. 201520383794.4 both titled “CORDLESS WINDOW COVERING” and filed with the Chinese State Intellectual Property Office on Jun. 5, 2015, the entire disclosures of which are incorporated herein by reference.

### TECHNICAL FIELD

The present application relates to the technical field of window coverings, and in particular to a cordless window covering.

### BACKGROUND

Currently, there are various forms of window covering, which can be classified into a corded type and a cordless type according to the manner of adjusting the height of the window covering. For the cordless type, a bottom of the window covering is applied with a force upward or downward by hand, to stretch or fold the window covering.

A cordless window covering mainly includes a window covering body, a transmission set and a pull cord. The transmission set is located at the top of the window covering body and is connected to the pull cord, and the window covering body is connected to the pull cord via the transmission set. The transmission set generally includes a spring device configured to be connected to the pull cord, and the pull cord is reeled up or released by the extension or contraction of the spring device, thereby moving the window covering body upward or downward.

The disadvantage of the existing cordless window covering is that the manner of winding the pull cord around the transmission set is complicated.

### SUMMARY

A cordless window covering is provided according to the present application, to simplify the winding manner of a pull cord.

The technical solution of a cordless window covering according to embodiments of the present application is described as follows. A cordless window covering includes a movable part, a telescopic part, a pull cord fixing seat and a pull cord. The telescopic part has one end configured to be fixedly connected to the external environment, and another end configured to be connected to the movable part, and the movable part is movable leftward and rightward along with the telescopic part. The pull cord fixing seat is configured to be fixedly connected to the external environment. The movable part is provided with at least one first transverse column arranged transversely, the pull cord fixing seat is provided with at least one second transverse column arranged transversely, and the pull cord passing through a window covering body is configured to be fixed to the movable part or the pull cord fixing seat after winding around the first transverse column and the second transverse column.

Preferably, a steering transverse column is further provided on the pull cord fixing seat, the pull cord passing through the window covering body is configured to wind around the first transverse column and the second transverse column after winding around the steering transverse column.

Preferably, the movable part is provided with at least one first spacer, and the first transverse column is arranged on the at least one first spacer transversely.

Preferably, the pull cord fixing seat is provided with at least one second spacer, and the second transverse column is arranged on the at least one spacer transversely.

Preferably, the cordless window covering further includes a guide rail, wherein a sliding groove configured to allow the movable part to slide therein is provided in the guide rail, to allow the movable part to be movable leftward and rightward with the telescopic part along the sliding groove.

Preferably, the cordless window covering further includes a telescopic part fixing seat, wherein the telescopic part fixing seat is fixed on the guide rail, and an end of the telescopic part is mounted on the telescopic part fixing seat.

Preferably, the pull cord fixing seat is fixed on the guide rail.

Preferably, the cordless window covering further includes a transmission shaft, a winder configured to be sleeved on the transmission shaft, a controller configured to be connected to an end of the transmission shaft and drive the transmission shaft to rotate, a handle configured to be connected to the controller and drive the controller to rotate, and a ladder tape configured to pass through the window covering body and to be fixed on the winder.

Preferably, the cordless window covering further includes a winder mounting seat, wherein the winder mounting seat is fixed on the guide rail, and the winder is arranged on the winder mounting seat.

Preferably, a retaining groove is provided on the winder mounting seat and is configured for accommodating the winder.

With the above technical solution, the pull cord passes through the window covering body and then winds around the first transverse column and the second transverse column, the movable part is slidable back and forth by pulling the window covering body downward or pushing the window covering body upward. When pulling the window covering body downward, the pull cord being pulled downward pulls the movable part and in turn stretches the telescopic part. When pushing the window covering body upward, the telescopic part tends to return to its original state due to an elastic restoring force, thus pulling the pull cord in an opposite direction, that is pulling the pull cord upward; when the window covering body is fixed at a certain position, the cordless window covering is overall in a state of force equilibrium, therefore, the winding manner is simple.

Secondly, a steering transverse column is also provided on the pull cord fixing seat, the pull cord passing through the window covering body first winds around the steering transverse column and then winds around the first transverse column and the second transverse column, the pull cord passing through the window covering body first winds around the steering transverse column, thus can wind around the first transverse column and the second transverse column in substantially a horizontal direction, thereby saving effort in pulling the pull cord.

Thirdly, each of the movable part and the pull cord fixing seat can be provided with at least one spacer, the spacers are configured separate the first transverse column and the second transverse column into several independent sub-areas, respectively. The pull cord is wound in the several independent sub-areas, and since the pull cords are wound around the first transverse column and the second transvers post, the pull cords winding around the first transverse column and the second transverse column are linked, thus the pull cord can be wound in any way without considering the winding manner of the pull cord, thus the winding is simple.

### BRIEF DESCRIPTION OF THE DRAWINGS

For more clearly illustrating embodiments of the present application or the technical solution in the conventional technology, drawings referred to describe the embodiments or the conventional technology will be briefly described hereinafter. Apparently, the drawings in the following description are only several embodiments of the present application, and for the person skilled in the art other drawings may be obtained based on these drawings without any creative efforts.

FIG. 1 is a schematic view showing the overall structure of a cordless window covering according to an embodiment of the present application;

FIG. 2 is a schematic view showing the internal structure of the cordless window covering according to the embodiment of the present application;

FIG. 3 is a schematic view showing the structure of a movable part of the cordless window covering according to the embodiment of FIG. 1;

FIG. 4 is a schematic view showing the structure of a pull cord fixing seat of the cordless window covering according to the embodiment of FIG. 1;

FIG. 5 is another schematic view showing the structure of a cordless window covering according to an embodiment of the present application;

FIG. 6 is a structural view showing the cordless window covering according to the embodiment of FIG. 5 controlling a window covering body to be retracted and unfolded;

FIG. 7 is a schematic view showing the structure of a pull cord fixing seat with a spacer of the cordless window covering according to the embodiment of FIG. 5;

FIG. 8 is a schematic view showing the structure of a pull cord fixing seat without a spacer of the cordless window covering according to the embodiment of FIG. 5;

FIG. 9 is a schematic view showing the structure of a movable part of the cordless window covering according to the embodiment of FIG. 5; and

FIG. 10 is a schematic view showing the structure of a telescopic part fixing seat of the cordless window covering according to the embodiment of FIG. 1.

Reference numerals in the above Figures:

| | |
|---|---|
| 1 telescopic part fixing seat, | 2 controller, |
| 3 winder fixing seat, | 4 transmission shaft, |
| 5 pull cord, | 6 movable par, |
| 7 pull cord fixing seat, | 8 telescopic part, |
| 9 guide rail, | 10 winder, |
| 11 window covering body, | 12 upper rail, |
| 13 lower rail. | |

### DETAILED DESCRIPTION

A cordless window covering is provided according to the present application, to simplify the winding manner of a pull cord.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

### First Embodiment

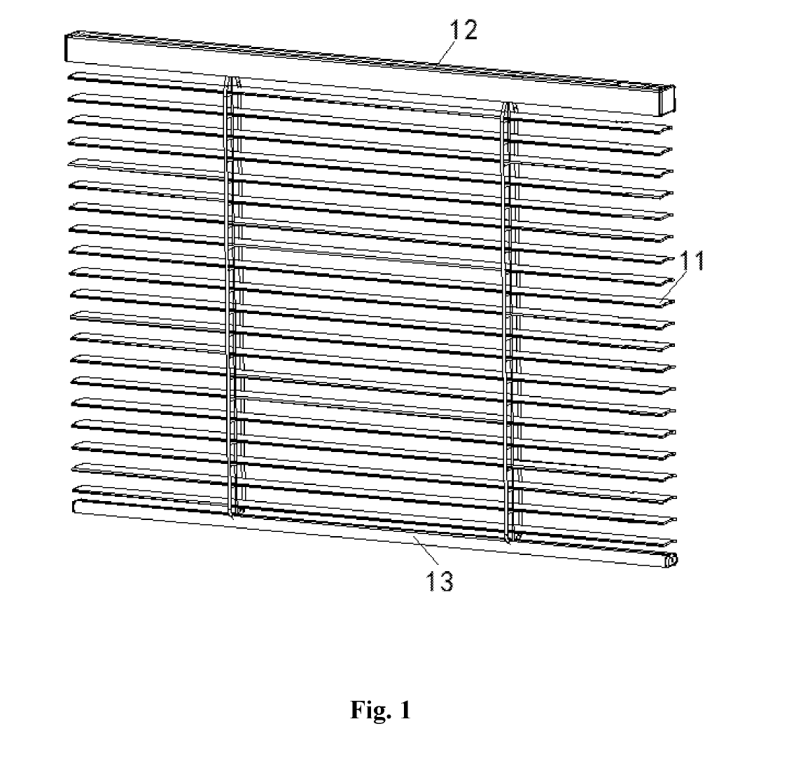

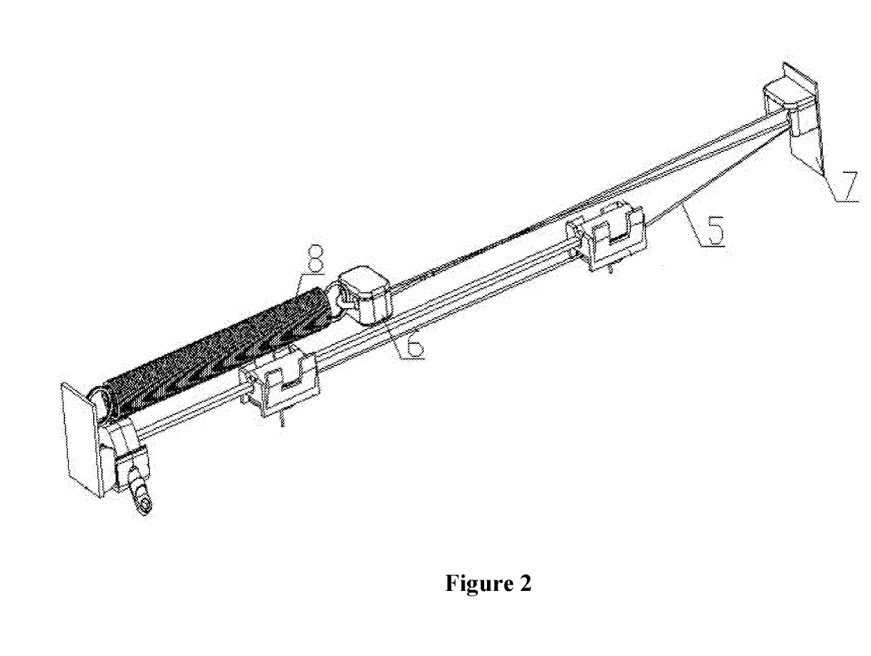

Referring to FIGS. 1 to 4, the technical solution of a cordless window covering according to an embodiment of the present application is described as follows. The cordless window covering includes a movable part 6, a telescopic part 8, a pull cord fixing seat 7 and a pull cord 5. The telescopic part 8 has one fixed end which may be fixedly connected to the external environment, and another end connected to the movable part 6. The movable part 6 is movable leftward and rightward with stretch and compression of the telescopic part 8, and the pull cord fixing seat 7 is configured to be connected to the external environment.

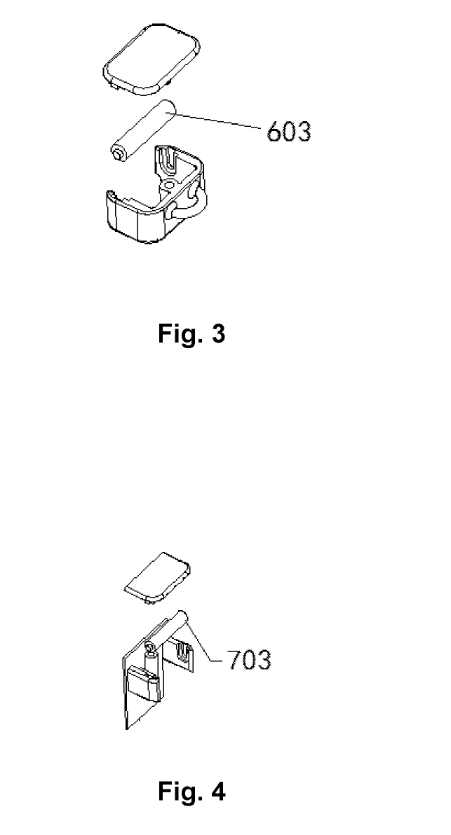

As shown in FIGS. 3 and 4, the movable part 6 is provided with a first transverse column 603 around which the pull cord 5 can be wound, and the pull cord fixing seat 7 is provided with a second transverse column 703 around which the pull cord 5 can be wound. Taking the cordless window covering in use as an example, arranging in a transverse direction refers to arranging in a horizontal direction, each of the first transverse column 603 and the second transverse column 703 is arranged transversely, and the pull cord 5 passing through the window covering body 11 is fixed on the movable part 6 or the pull cord fixing seat 7 after winding around the first transverse column 603 and the second transverse column 703.

It is to be noted that, in this embodiment, the movable part 6, the telescopic part 8 and the pull cord fixing seat 7 can be located inside an upper rail 12 of the window covering body 11, and can also be located inside a lower rail 13 of the window covering body 11, the specific positions for mounting the above parts are not limited as long as the opening or closing of the window covering body 11 can be achieved.

It is to be noted that, in this embodiment, the telescopic part 8 is generally pre-stretched by a certain distance when the window covering body 11 is retracted completely. When the telescopic part 8 is stretched by a certain distance, the telescopic part 8 is in a stretched state, and the pull cord 5 is in a tightened state, which saves effort in pulling the window covering body 11 downward or pushing the window covering body 11 upward.

With the above technical solution, the pull cord 5 passes through the window covering body 11 and then winds around the first transverse column 603 and the second transverse column 703, the movable part 6 is slidable back and forth by pulling the window covering body 11 downward or pushing the window covering body 11 upward. When pulling the window covering body 11 downward, the pull cord 5 being pulled downward pulls the movable part 6 and in turn stretches the telescopic part 8. When pushing the window covering body 11 upward, the telescopic part 8 tends to return to its original state due to an elastic restoring force, thus pulling the pull cord 5 in an opposite direction, that is pulling the pull cord 5 upward; when the window covering body 11 is fixed at a certain position, the cordless window covering is overall in a state of force equilibrium, therefore, the winding manner is simple.

### Second Embodiment

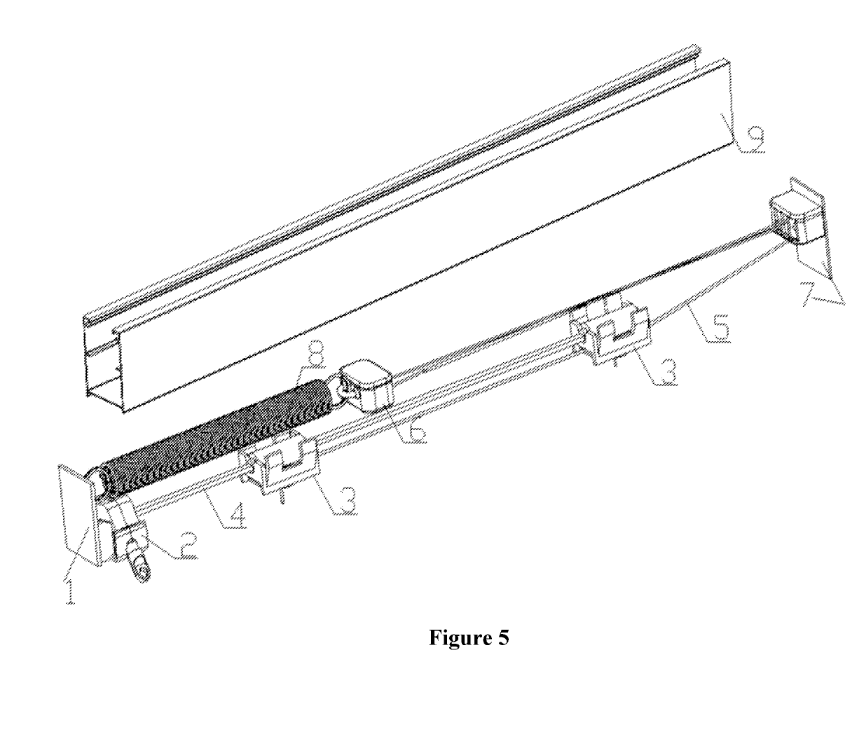

Referring to FIGS. 5 to 10, a cordless window covering is provided according to an embodiment of the present application. The cordless window covering is fixedly connected to the external environment, and the technical solution of the cordless window covering is described as follows. The cordless window covering mainly includes a guide rail 9, a movable part 6, a telescopic part 8, and a pull cord fixing seat 7 fixed at the guide rail 9. A sliding groove (not shown) configured to allow the movable part 6 to slide leftward and rightward is provided in the guide rail 9. The pull cord fixing seat 7 can be fixed at any position of the guide rail 9, and is not limited to be fixed at an outermost end of the guide rail 9 as shown in FIG. 5.

The telescopic part 8 has one end connected to the guide rail 9 and another end connected to the movable part 6. In this embodiment, since one end of the telescopic part 8 is connected to the guide rail 9, the cordless window covering may further include a telescopic part fixing seat 1, the telescopic part fixing seat 1 can be fixed at any position of the guide rail 9, and is not limited to be fixed at the outermost end of the guide rail 9 as shown in FIG. 5.

One end of the telescopic part 8 is connected to the telescopic part fixing seat 1, it could be further noted that, as shown in FIG. 10, a circular ring can be provided on the telescopic part fixing seat 1, one end of the telescopic part 8, such as a spring, is linked with the circular ring to connect the telescopic part 8 to the telescopic part fixing seat 1.

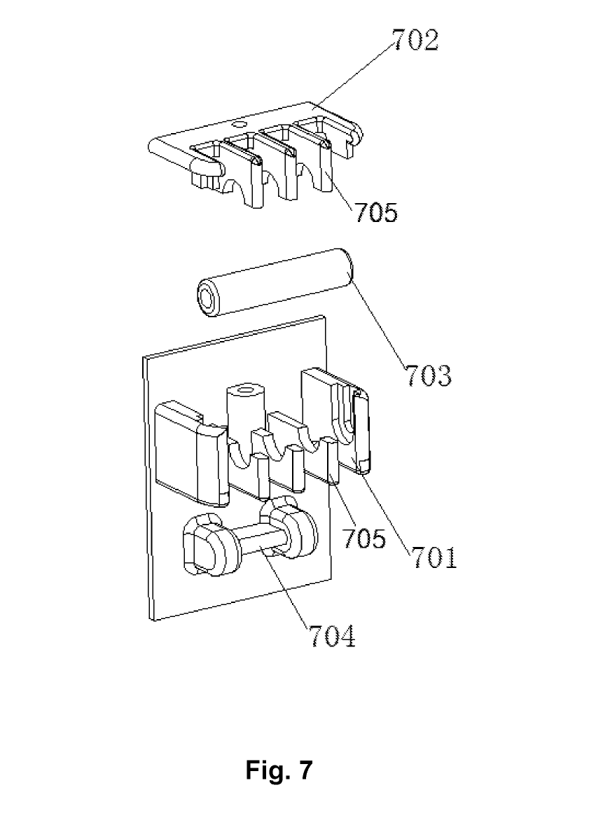

As shown in FIGS. 7 to 9, the movable part 6 is provided with a first transverse column 603 around which the pull cord 5 can be wound, and the pull cord fixing seat 7 is provided with a second transverse column 703 around which the pull cord 5 can be wound. It is to be noted that, in this embodiment, the number of each of the first transverse column 603 and the second transverse column 703 may be one as shown in the Figures, however, the number of each of the first transverse column 603 and the second transverse column 703 is not limited to one as shown in the Figures, and can also be set according to practical situation, and the number of each of the first transverse column 603 and the second transverse column 703 can also be more than two (including two).

With the above technical solution, the pull cord 5 passes through the window covering body (the window covering body 11 as shown in FIG. 1) and winds around the first transverse column 603 and the second transverse column 703, the movable part 6 can be pulled downward by the pull cord 5 to slide in the sliding groove of the guide rail 9, and the telescopic part 8 can be stretched to move the window covering body downward. By pushing the lower rail (the lower rail 13 as shown in FIG. 1, the lower rail is located at the very bottom of the window covering body) of the window covering body upward, the telescopic part 8 pulls the pull cord in the opposite direction due to an elastic restoring force, to move the window covering body upward. In the process of the upward and downward movement of the window covering body, the pull cord 5 winds around the first transverse column 603 of the movable part 6 and the second transverse column 703 of the pull cord fixing seat 7 back and forth.

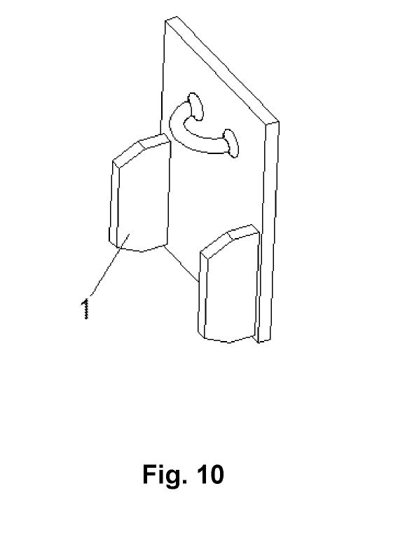

As shown in FIGS. 7 and 9, the cordless window covering is chosen according to the specific size of usage occasion, when the external environment is relatively small, the guide rail 9 of the cordless window covering can not be oversized, therefore, in order to facilitate adjusting the length of the window covering body within a wide range, the movable part 6 can be provided with several (several means at least one) first spacers 604, and the pull cord fixing seat 7 can be provided with several (several means at least one) second spacers 705, and the first spacers 604 and the second spacers 705 can separate the first transverse column 603 and the second transverse column 703 into several independent sub-areas, respectively, and thus the pull cord 5 can be divided into several independent sub-areas by the first spacers 604 and the second spacers 705, and the pull cord 5 can wind around back and forth in the several independent sub-areas. By using the technical solution, the more the number of turns of the pull cord 5 winding around back and forth, the longer the length of the pull cord 5 on the window covering body, and the pull cords 5 in the several independent sub-areas will not interfere with each other, thereby avoiding kinking. Moreover, since the pull cords 5 are winding around the first transverse column 603 and the second transverse column 703, the pull cords 5 winding around the first transverse column 603 and the second transverse column 703 are linked, thus will not be applied with different forces when winding around the different independent sub-areas, thus the pull cord 5 can be wound in the several independent sub-areas in any manner without considering the winding manner of the pull cord 5. Furthermore, the number of each of the first transverse column 603 and the second transverse column 703 is reduced by providing the first spacers 604 and the second spacers 705, thus the structure is simple.

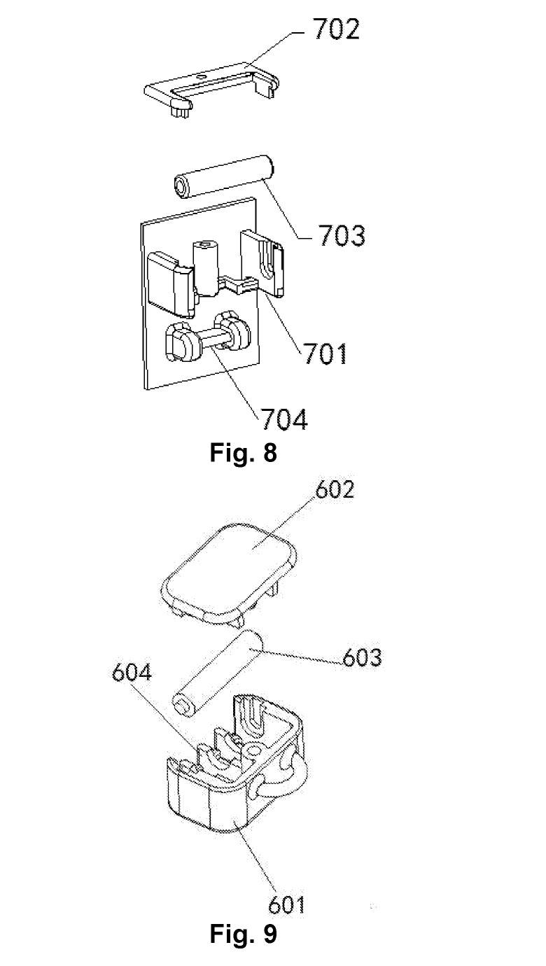

It is further noted that, as shown in FIGS. 7 and 8, a steering transverse column 704 may also be provided on the pull cord fixing seat 7. The steering transverse column 704 is located below the second transverse column 703, and the steering transverse column 704 and the position where the pull cord 5 is located after passing through the window covering body are substantially in one horizontal plane. The pull cord 5 passing through the window covering body first winds around the steering transverse column 704 and then winds around the first transverse column 603 and the second transverse column 703 back and forth, thereby avoiding the pull cord 5 from titling at a certain angle when the pull cord 5 directly winds around the first transverse column 603 and the second transverse column 703. After passing through the steering transverse column 704, the pull cord 5 winds around the first transverse column 603 and the second transverse column 703 back and forth in a substantially horizontal direction, thereby saving effort in pulling the pull cord 5.

It is further noted that, as shown in FIG. 9, the end of the movable part 6 that is connected to the telescopic part 8 may be provided with a circular ring, the telescopic part 8, such as a spring, is linked with the circular ring on the outer surface of the movable part 6 to be connected to the movable part 6. The movable part 6 may include a main body 601 and a cover plate 602 located on the main body 601. Several (more than or equal to one) first spacers 604 are provided between the main body 601 and the cover plate 602, a through hole configured to allow the first transverse column 603 to pass through is provided in each first spacer 604, the several first spacers 604 separate the first transverse column 603 into several independent sub-areas, and the pull cord 5 is wound around the first transverse column 603 in the several independent sub-areas.

It is further noted that, as shown in FIG. 7, the pull cord fixing seat 7 includes a main body 701 and a cover plate 702 located on the main body 701. Several (more than or equal to one) second spacers 705 are provided between the main body 701 and the cover plate 702, a through hole configured to allow the second transverse column 703 to pass through is provided in each second spacer 705, the several second spacers 705 separate the second transverse column 703 into several independent sub-areas, and the pull cord 5 is wound around the second transverse column 703 in the several independent sub-areas. It could be understood that, as shown in FIG. 8, the pull cord fixing seat 7 may not be provided with the second spacer.

It is to be noted that, in this embodiment, each of the first transverse column 603 and the second transverse column 703 is arranged in a horizontal direction, and the first transverse column 603 and the second transverse column 703 may also be arranged in a vertical direction according to the heights of the guide rail 9, the movable part 6 and the pull cord fixing seat 7, and when the first transverse column 603 and the second transverse column 703 are arranged vertically, the spacers are arranged transversely.

In the specific use, each of the following is not limited specifically: the number of each of the first transverse column 603 and the second transverse column 703; transversely or vertically arranging the first transverse column 603 and the second transverse column 703; whether or not providing spacers in the first transverse column 603 and the second transverse column 703; and the number of spacers when the first transverse column 603 and the second transverse column 703 are provided with the spacers.

It is to be noted that, in this embodiment, the telescopic part 8 can be a spring, and also a rubber band; the telescopic part 8 may also be made of other stretchable materials, and will not be limited specifically herein.

Same as the first embodiment, in this embodiment, the movable part 6, the telescopic part 8 and the pull cord fixing seat 7 can be located in the upper rail of the window covering body, and may also be located in the lower rail of the window covering body, and the specific position thereof is not limited.

With the above technical solution, the window covering body can move upward or downward, the cordless window covering is applicable to pleated blinds, organ shade, venetian blinds, Roman blinds, and etc.

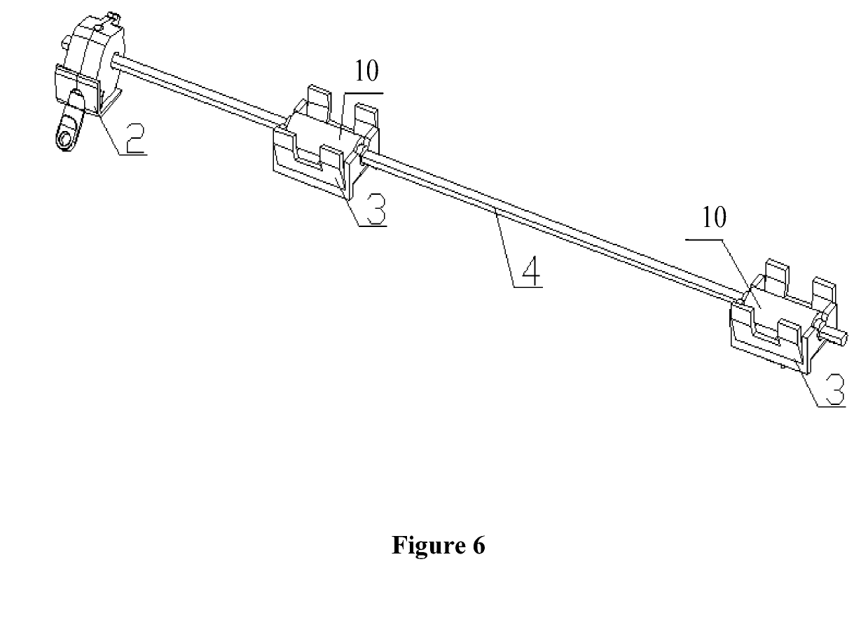

When the window covering body is a venetian blind, the cordless window covering may further include a venetian blind controller configured to control the window covering body to be reeled up or unfolded. As shown in FIG. 6, the venetian blind controller includes: a transmission shaft 4, a winder 10 sleeved on the transmission shaft 4, a controller 2 connected to an end of the transmission shaft 4 and configured to drive the transmission shaft 4 to rotate, a handle connected to the controller 2 and configured to drive the controller 2 to rotate, and a ladder tape passing through the window covering body (the window covering body 11 as shown in FIG. 1) and fixed on the winder 10. The handle is rotated by hand, to drive the controller 2 to rotate, thus the transmission shaft 4 can rotate counterclockwise or clockwise, the winder 10 sleeved on the transmission shaft 4 rotates counterclockwise or clockwise with the transmission shaft 4, and the winder 10 rolls the ladder tape passing through the window covering body (the window covering body 11 as shown in FIG. 1), thereby reeling up or unfolding the window covering body.

Preferably, the venetian blind controller may further include a winder mounting seat 3, the winder mounting seat 3 can be fixed on the guide rail 9, and the winder 10 is arranged on the winder mounting seat 3.

Preferably, a retaining groove configured for accommodating the winder 10 is provided on the winder mounting seat 3.

The present application has been described in detail above, for those skilled in the art, modifications to the specific embodiments and the application range could be made based on the ideal of the embodiments of the present application. In conclusion, the content of the specification should not be interpreted as limitation to the present application.

What is claimed is:

1. A cordless window covering, comprising a movable part, a telescopic part, a pull cord fixing seat and a pull cord; wherein,
the telescopic part has one end configured to be fixedly connected to the external environment, and another end configured to be connected to the movable part, and the movable part is movable leftward and rightward along with the telescopic part;
the pull cord fixing seat is configured to be fixedly connected to the external environment; and
the movable part is provided with at least one first transverse column arranged transversely, the pull cord fixing seat is provided with at least one second transverse column arranged transversely, and the pull cord passing through a window covering body is configured to be fixed to the movable part or the pull cord fixing seat after winding around the first transverse column and the second transverse column.

2. The cordless window covering according to claim 1, wherein a steering transverse column is further provided on the pull cord fixing seat, the pull cord passing through the window covering body is configured to wind around the first transverse column and the second transverse column after winding around the steering transverse column.

3. The cordless window covering according to claim 2, wherein the movable part is provided with at least one first spacer, and the first transverse column is arranged on the at least one first spacer transversely.

4. The cordless window covering according to claim 3, wherein the pull cord fixing seat is provided with at least one second spacer, and the second transverse column is arranged on the at least one spacer transversely.

5. The cordless window covering according to claim 1, further comprising a guide rail, wherein a sliding groove configured to allow the movable part to slide therein is provided in the guide rail, to allow the movable part to be movable leftward and rightward with the telescopic part along the sliding groove.

6. The cordless window covering according to claim 5, further comprising a telescopic part fixing seat, wherein the telescopic part fixing seat is fixed on the guide rail, and an end of the telescopic part is mounted on the telescopic part fixing seat.

7. The cordless window covering according to claim 5, wherein the pull cord fixing seat is fixed on the guide rail.

8. The cordless window covering according to claim 5, further comprising a transmission shaft, a winder configured to be sleeved on the transmission shaft, a controller configured to be connected to an end of the transmission shaft and drive the transmission shaft to rotate, a handle configured to be connected to the controller and drive the controller to rotate, and a ladder tape configured to pass through the window covering body and to be fixed on the winder.

9. The cordless window covering according to claim 8, further comprising a winder mounting seat, wherein the winder mounting seat is fixed on the guide rail, and the winder is arranged on the winder mounting seat.

10. The cordless window covering according to claim 9, wherein a retaining groove is provided on the winder mounting seat and is configured for accommodating the winder.

11. The cordless window covering according to claim 2, further comprising a guide rail, wherein a sliding groove configured to allow the movable part to slide therein is provided in the guide rail, to allow the movable part to be movable leftward and rightward with the telescopic part along the sliding groove.

12. The cordless window covering according to claim 10, further comprising a telescopic part fixing seat, wherein the telescopic part fixing seat is fixed on the guide rail, and an end of the telescopic part is mounted on the telescopic part fixing seat.

13. The cordless window covering according to claim 10, wherein the pull cord fixing seat is fixed on the guide rail.

14. The cordless window covering according to claim 10, further comprising a transmission shaft, a winder configured to be sleeved on the transmission shaft, a controller configured to be connected to an end of the transmission shaft and drive the transmission shaft to rotate, a handle configured to be connected to the controller and drive the controller to rotate, and a ladder tape configured to pass through the window covering body and to be fixed on the winder.

15. The cordless window covering according to claim 3, further comprising a guide rail, wherein a sliding groove configured to allow the movable part to slide therein is provided in the guide rail, to allow the movable part to be movable leftward and rightward with the telescopic part along the sliding groove.

16. The cordless window covering according to claim 15, further comprising a telescopic part fixing seat, wherein the telescopic part fixing seat is fixed on the guide rail, and an end of the telescopic part is mounted on the telescopic part fixing seat.

17. The cordless window covering according to claim 15, wherein the pull cord fixing seat is fixed on the guide rail.

18. The cordless window covering according to claim 15, further comprising a transmission shaft, a winder configured to be sleeved on the transmission shaft, a controller configured to be connected to an end of the transmission shaft and drive the transmission shaft to rotate, a handle configured to be connected to the controller and drive the controller to rotate, and a ladder tape configured to pass through the window covering body and to be fixed on the winder.

19. The cordless window covering according to claim 4, further comprising a guide rail, wherein a sliding groove configured to allow the movable part to slide therein is provided in the guide rail, to allow the movable part to be movable leftward and rightward with the telescopic part along the sliding groove.

20. The cordless window covering according to claim 19, further comprising a telescopic part fixing seat, wherein the telescopic part fixing seat is fixed on the guide rail, and an end of the telescopic part is mounted on the telescopic part fixing seat.
